(19) United States
(12) Patent Application Publication
(10) Pub. No.: US 2017/0111975 A1
(43) Pub. Date: Apr. 20, 2017

(54) DISPLAY APPARATUS AND METHOD FOR CONTROLLING THE SAME

(71) Applicant: SAMSUNG ELECTRONICS CO., LTD., Suwon-si (KR)

(72) Inventors: Woong-Ki LEE, Yongin-si (KR); Kil Soo PARK, Suwon-si (KR)

(73) Assignee: SAMSUNG ELECTRONICS CO., LTD., Suwon-si (KR)

(21) Appl. No.: 15/251,205

(22) Filed: Aug. 30, 2016

(30) Foreign Application Priority Data
Oct. 19, 2015 (KR) 10-2015-0145273

(51) Int. Cl. H05B 37/02; G09G 3/34

(52) U.S. Cl. CPC H05B 37/0245; G09G 3/3406; G09G 2320/0646; G09G 2320/066

(57) ABSTRACT

A display apparatus and a method for allowing the display apparatus to generate a dimming signal needed to control dimming of images displayed on the display apparatus or the external device, and controlling not only brightness of the images displayed on the display apparatus or the external device but also illumination intensity of peripheral external lighting devices, and a method for controlling the same.

### CROSS-REFERENCE TO RELATED APPLICATION

This application claims priority from Korean Patent Application No. 10-2015-0145273, filed on Oct. 19, 2015 in the Korean Intellectual Property Office, the disclosure of which is incorporated herein by reference.

### BACKGROUND

1. Field

Apparatuses and methods consistent with exemplary embodiments relate to a display apparatus and a method for controlling the same.

2. Description of the Related Art

A display apparatus displays visual and stereoscopic image information. In recent years, there have been developed flat display devices which have lower weight and volume than a cathode ray tube (CRT) and may be installed in a wide variety of spaces, thereby easily achieving large-scale image realization, flat structure, and high quality.

Representative examples of such flat display devices include a liquid crystal display (LCD), an electroluminescent display (ELD), a field emission display (FED), a plasma display panel (PDP), a thin film transistor liquid crystal display device (TFT-LCD), and a flexible display.

Generally, brightness of each pixel for use in an LCD may be determined to be a product of brightness of a backlight unit and a liquid-crystal light transmittance depending upon data. In order to increase a contrast ratio as well as to reduce power consumption, the LCD is configured to use a backlight dimming scheme that analyzes an input image and adjusts a dimming value to control brightness of a backlight unit as well as to compensate for data. Recently, the backlight unit uses a light emitting diode (LED) backlight unit configured to use an LED having higher brightness and lower power consumption than the conventional lamp, as a light source. Since the LED backlight unit may perform brightness control for each position, the LED backlight unit may be driven by a local dimming method that divides an LED into a plurality of light emitting blocks and controls brightness of each block.

Generally, a plurality of lighting devices may be installed indoors, and each lighting device may be turned on or off by a switch connected by wire or wirelessly. In this case, the lighting devices may be simultaneously turned on or off, or may be turned on or off independently of each other.

If images are displayed on the display apparatus, definition or clarity of the displayed images may be determined according to illumination intensity of a peripheral region of the display apparatus. In recent years, many developers and companies are conducting research into a method for adjusting illumination intensity of an external lighting device to increase definition of images displayed on the display apparatus, and are also conducting research into another method for allowing a designated display apparatus to control a dimming value of another external device.

### SUMMARY

Exemplary embodiments may address at least the above problems and/or disadvantages and other disadvantages not described above. Also, the exemplary embodiments are not required to overcome the disadvantages described above, and may not overcome any of the problems described above.

According to an aspect of one or more exemplary embodiments, there is provided, when images are displayed on a display apparatus or an external device, a method for allowing the display apparatus to generate a dimming signal to control dimming of images displayed on the display apparatus or the external device, and controlling not only brightness of the images displayed on the display apparatus or the external device but also illumination intensity of peripheral external lighting devices, and a method for controlling the same.

Additional aspects will be set forth in part in the description which follows and, in part, will be obvious from the description, or may be learned by practice.

According to an aspect of an exemplary embodiment, there is provided a display apparatus including: a display configured to display an image; a controller configured to generate a dimming signal for adjusting a brightness of an external lighting device based on a brightness of an image signal outputted from the display apparatus; and a communicator configured to transmit the dimming signal to the external lighting device to adjust the brightness of the external lighting device based on the generated dimming signal.

The controller may be configured to generate a dimming signal for adjusting the brightness of the external lighting device in proportion to the brightness of the image signal outputted from the display apparatus.

The controller may be configured to generate a dimming signal for adjusting a brightness of an image outputted from an external device based on a brightness of the image signal outputted from the external device.

The controller may be configured to generate a dimming signal for adjusting the brightness of the external lighting device based on a brightness of an image signal outputted from an external device.

The controller may be configured to generate a dimming signal for adjusting the brightness of the image outputted from the external device in proportion to the brightness of the image signal outputted from the external device.

The controller may be configured to generate a dimming signal for adjusting the brightness of the external lighting device in proportion to the brightness of the image signal outputted from the external device.

The controller may be configured to control a backlight unit (BLU) of the display apparatus based on the generated dimming signal, thereby adjusting a brightness of an image outputted from the display apparatus.

The communicator may be configured to transmit a dimming signal, generated to adjust the brightness of the image outputted from the external device, to the external device.

The communicator may be configured to transmit the dimming signal, generated to adjust the brightness of the external lighting device, to the external lighting device.

The communicator may be configured to receive an image signal including brightness information of an image outputted from an external device.

According to an aspect of another exemplary embodiment, there is provided a method for controlling a display apparatus including: receiving an image signal needed to display an image on the display apparatus; generating a dimming signal for adjusting brightness of an external lighting device based on a brightness of the received image signal; and transmitting the dimming signal to the external lighting device to adjust the brightness of the external lighting device based on the generated dimming signal.

The method may include receiving an image signal including brightness information of an image outputted from an external device.

The method may include generating a dimming signal for adjusting the brightness of the image outputted from the external device based on the brightness of the image signal outputted from the external device.

The method may include generating a dimming signal for adjusting the brightness of the external lighting device based on a brightness of an image signal outputted from the external device.

The generating the dimming signal may include: generating a dimming signal for adjusting the brightness of the external lighting device in proportion to the brightness of the received image signal.

The generating the dimming signal may include: generating a dimming signal for adjusting the brightness of the image outputted from the external device in proportion to the brightness of the image signal outputted from the external device.

The generating the dimming signal may include: generating a dimming signal for adjusting the brightness of the external lighting device in proportion to the brightness of the image signal outputted from the external device.

The method may include controlling a backlight unit (BLU) of the display apparatus based on the generated dimming signal, thereby adjusting a brightness of an image outputted from the display apparatus.

The method may include transmitting the dimming signal, generated to adjust the brightness of the image outputted from the external device, to the external lighting device.

The method may include transmitting the dimming signal, generated to adjust brightness of the external lighting device, to the external lighting device.

### BRIEF DESCRIPTION OF THE DRAWINGS

These and/or other aspects will become apparent and more readily appreciated from the following description of exemplary embodiments, taken in conjunction with the accompanying drawings of which:

FIG. 1 is a perspective view illustrating the appearance of a display apparatus according to an exemplary embodiment;

FIG. 2 is an exploded view illustrating the display apparatus according to an exemplary embodiment;

FIG. 3 is a side cross-sectional view illustrating the display apparatus according to an exemplary embodiment;

FIG. 4 is a control block diagram illustrating control flow of a display apparatus according to an exemplary embodiment;

FIGS. 5 to 7 are conceptual diagrams illustrating a method for allowing the display apparatus to generate a dimming signal according to an exemplary embodiment;

FIGS. 8 to 10 are conceptual diagrams illustrating a method for allowing the display apparatus to transmit a generated dimming signal to an external lighting device according to an exemplary embodiment;

FIG. 11 is a conceptual diagram illustrating a method for allowing the display apparatus to receive an image signal from an external device as well as to adjust image brightness according to an exemplary embodiment;

FIG. 12 is a conceptual diagram illustrating a method for transmitting the dimming signal generated by the display apparatus to the external device and the external lighting device, according to an exemplary embodiment;

FIGS. 13 and 14 are flowcharts illustrating a method for controlling the display apparatus according to an exemplary embodiment.

### DETAILED DESCRIPTION

Advantages and features will be clearly understood from the exemplary embodiments described below in conjunction with the accompanying drawings. However, the present disclosure is not limited to the exemplary embodiments and may be realized in various different forms. The same reference numbers will be used throughout this specification to refer to the same parts.

Although most terms of elements in the present disclosure have been selected from general terms widely used in the art, the terms may be changed depending on the intention or convention of those skilled in the art or the introduction of new technology. Some terms have been selected by the applicant and their meanings are explained in the description below. Thus, the terms used in this specification should be construed based on the overall content of the present disclosure together with the actual meanings of the terms rather than their simple names or meanings.

Throughout the present disclosure, the term ‘comprising or including’ means that a corresponding component may further include other components unless a specific meaning opposed to the corresponding component is written.

When a certain part “includes” a certain element, it means that the part can further include other elements. The term “module”, “portion”, or “circuit” may include software components and/or hardware components, such as a field programmable gate array (FPGA) or an application specific integrated circuit (ASIC), to perform a specific function. However, the term “module” (portion or circuit) is not limited to software or hardware. The module (portion or circuit) may be configured to be present in an addressable storage medium or to execute one or more processors. For example, the module (portion or circuit) may include components, such as software components, object-oriented software components, class components, and task components, processes, functions, attributes, procedures, subroutines, segments of a program code, drivers, firmware, microcode, circuitry, data, databases, data structures, tables, arrays, and variables. Functions provided by the components and modules may be combined into fewer components and modules or further divided into additional components and modules.

Exemplary embodiments will be described in detail so that those skilled in the art may readily implement the present disclosure. However, the present disclosure may be implemented in different manners, and is not limited to the exemplary embodiments described herein. Parts that are not related to a description of the present disclosure are omitted in the drawings and like reference numerals denote the same components through the disclosure.

The user may view images displayed on the display apparatus. Definition of the displayed images may be determined according to illumination intensity of a peripheral region of the display apparatus. For example, assuming that the peripheral region of the display apparatus is dark and images displayed on the display apparatus are bright, the user's eyes are fatigued. Assuming that the peripheral region of the display apparatus is bright and images displayed on the display apparatus are dark, it is difficult to distinguish between light and dark, such that the user may have difficulty in normally and visually recognizing images displayed on the display apparatus.

In order to address the above-mentioned issues, although the conventional display apparatus has been designed to adjust brightness of images displayed on the display apparatus according to illumination intensity of the lighting or lamp located in the peripheral region, various types of images may be displayed on the display apparatus, and a bright screen image and a dark screen image may be displayed in real time, such that the conventional display apparatus has difficulty in controlling brightness of images displayed in real time in consideration of illumination intensity of the lighting and lamp installed in the peripheral region.

Therefore, the display apparatus and the method for controlling the same according to an exemplary embodiment may adjust peripheral illumination in response to brightness of images displayed on the display apparatus, such that the image display environment for allowing the user to view high-definition images in real time may be optimized. For convenience of description, it is assumed that the term “illumination intensity” or “intensity” has the same meaning as the term “brightness”.

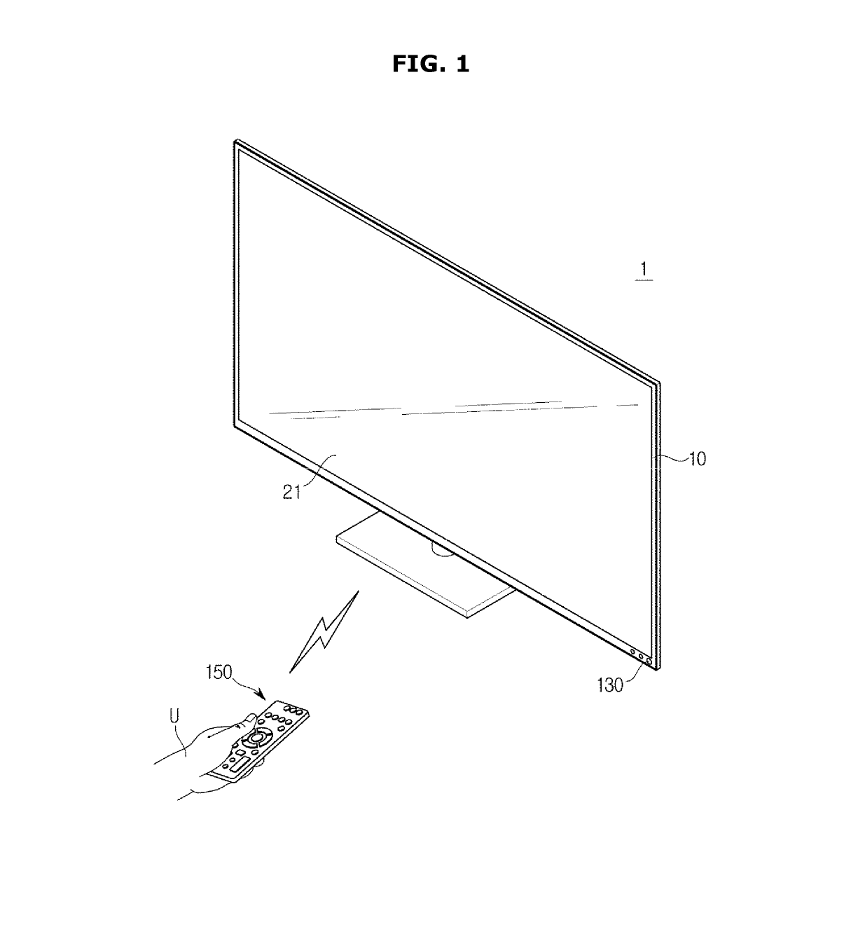

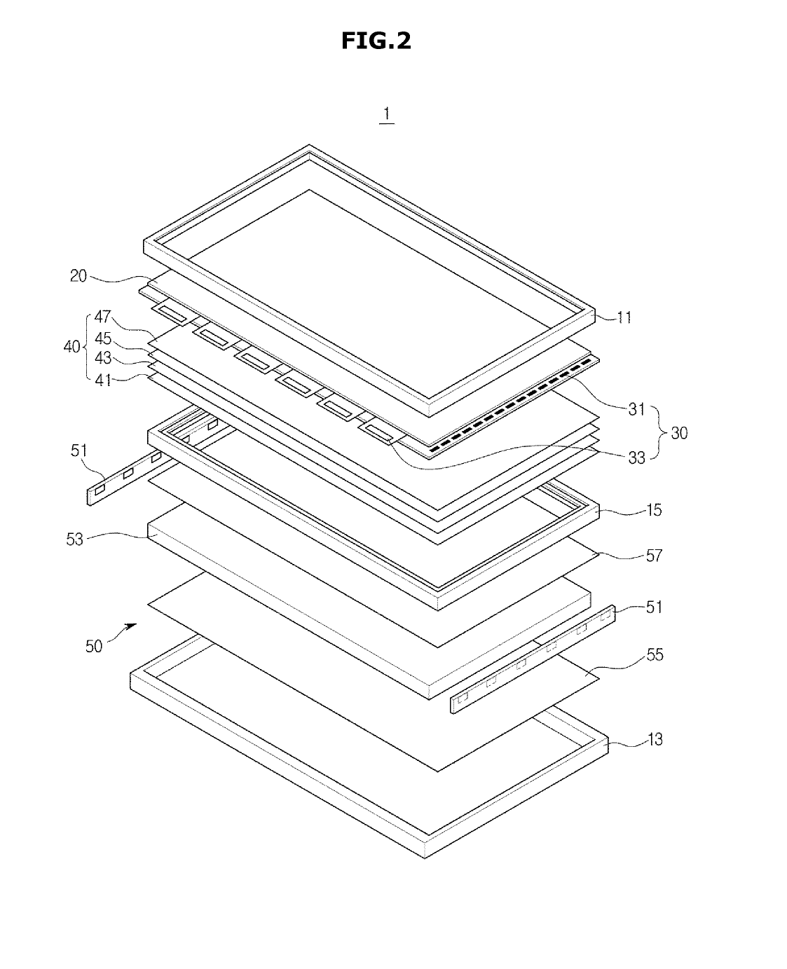

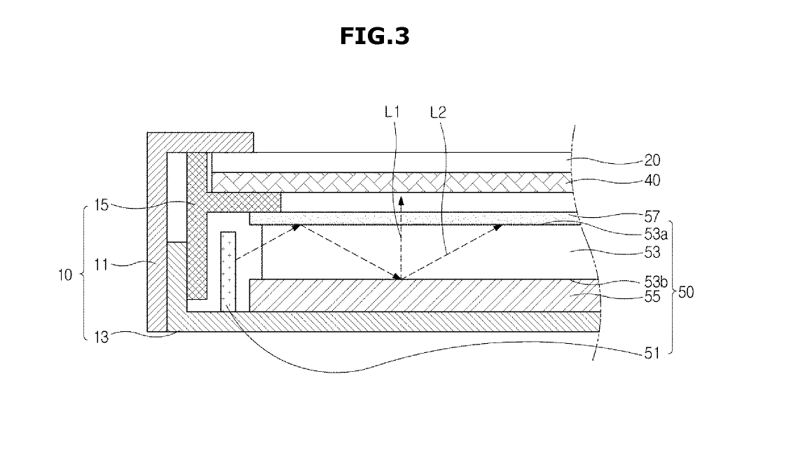

FIG. 1 is a perspective view illustrating the appearance of a display apparatus according to an exemplary embodiment. FIG. 2 is an exploded view illustrating the display apparatus according to an exemplary embodiment. FIG. 3 is a side cross-sectional view illustrating the display apparatus according to an exemplary embodiment.

The display apparatus 1 may process an image signal received from the external part, and may visually display the processed image signal thereon. Although the display apparatus 1 is assumed to be a television (TV) by way of an example, exemplary embodiments are not limited thereto. For example, the display apparatus may be implemented in various ways, for example, a monitor, a portable multimedia device, a mobile communication device, etc., and may also be applied to all kinds of image display devices configured to visually display various images.

Referring to FIGS. 1 to 3, the display apparatus 1 may include a main body 10 including various electronic components and a display panel 21 configured to display images for recognition of a user U. In addition, the main body 10 may include a drive circuit 30, a backlight unit (BLU) 50, and an optical sheet 40. The optical sheet 40 may include a plurality of optical sheets 41, 43, 45, and 47.

In this case, the display panel 21 may be one constituent element of the display 20, and may be configured to display images upon receiving a control signal from the controller 140.

The main body 10 may include a top chassis 11 provided to a front surface of the display apparatus 1, a bottom chassis 13 provided to a back surface of the display apparatus 1, and a mold frame 15 contained in the display apparatus 1.

The top chassis 11 may be provided at an image display surface of the display panel 21, and may prevent exposure of an edge part of the display panel 21.

The bottom chassis 13 may be provided at another surface opposite to the image display surface of the display panel 21, and may prevent exposure of various constituent elements contained in the display apparatus 1. In addition, the bottom chassis 13 may protect various constituent elements contained in the display apparatus 1 from external impact.

The mold frame 15 may restrict movement of the display panel 21, the optical sheet 40, and the backlight unit (BLU) 50, and may fix the display panel 21, the optical sheet 40, and the BLU 50 to the top chassis 11 and the bottom chassis 13.

The display panel 21 may display various images according to externally input image signals.

The display panel 21 may be a light emitting display panel in which a plurality of pixels constructing the display panel 21 may autonomously emit light to form images, or may be a non-light-emitting display panel in which a plurality of pixels reflects, transmits, and blocks light to form images.

For convenience of description, the display panel 21 is described as a non-light-emitting display panel to form images by reflecting, transmitting, and blocking light generated by the BLU 50.

The display panel 21 may include a liquid crystal layer, a transparent electrode layer, a transparent substrate, and a color filter array.

The liquid crystal layer may include a liquid crystal. The liquid crystal may be an intermediate state between a crystal state and a liquid state. Optical characteristics of the liquid crystal may be varied according to change in applied voltage. For example, the direction of arrangement of molecules constructing the liquid crystal may be changed according to a change of an electric field applied to the liquid crystal.

One pair of transparent electrode layers to form the electric field in the liquid crystal layer may be provided at both sides of the liquid crystal layer. The electric field applied to the liquid crystal layer may be changed according to the change of a voltage applied between one pair of transparent electrode layers.

The transparent electrode layer may include a gate line, a data line, and a thin film transistor (TFT).

The gate line may be arranged in a row direction to turn the TFT on or off according to a gate signal, and the data line may be arranged in a column direction to transmit a data signal to a plurality of pixels through the TFT. As described above, the electric field applied to the liquid crystal layer may be changed according to not only the gate signal received through the gate line but also the data signal received through the data line, and the molecular arrangement of liquid crystals may be changed according to change of the electric field. In addition, light may or may not transmit the liquid crystal layer according to the molecular arrangement of liquid crystals.

The gate line and the data line may be formed of Indium Tin Oxide (ITO), Indium Zinc Oxide (IZO), or the like.

One pair of transparent substrates may form an external appearance of the display panel 21, and may protect a liquid crystal layer and a transparent electrode layer. The transparent substrate may be formed of tempered glass or transparent film having superior light transmittance.

The color filter layer may include a red color filter, a blue color filter, and a green color filter which are formed in different regions corresponding to respective pixels in a manner that different colors are displayed on the respective pixels constructing the display panel 21.

As described above, the display panel 21 may block or transmit light generated by the backlight unit (BLU) 50, resulting in formation of images. In more detail, the respective pixels constructing the display panel 21 may block or transmit the light of the BLU 50, resulting in formation of various colors of images.

The drive circuit 30 may supply a drive signal for driving the display panel 21 to the display panel 21. The drive circuit 30 may include a gate drive circuit 31 and a data drive circuit 33.

The gate drive circuit 31 may be coupled to a gate line of the display panel 21, and may output a gate signal to the gate line. In addition, the data drive circuit 33 may be coupled to a data line of the display panel 21, and may output a data signal to the data line.

The BLU 50 may be installed at the rear of the display panel 21, and may generate light for allowing the display panel 21 to display images. The BLU 50 may be classified into an edge-type BLU including a light source located at the side thereof and a direct-type BLU in which a light source is located at the rear of the display panel 21.

Although it is assumed that the BLU 50 is implemented as the edge-type BLU including the light source located at the side thereof for convenience of description, a quantum dot sheet 57 to be described later may also be applied to the direct-type BLU.

Referring to FIG. 3, the BLU 50 may include a light source 51 to generate light, a Light Guide Plate (LGP) 53 to convert the light generated from the light source 51 into a sheet light, a reflective sheet 55 provided at a back surface of the light guide plate (LGP) 53 so as to reflect the light received from the LGP 53, and a quantum dot sheet 57 to generate white light (in which various colors of light signals are mixed) upon receiving the light from the LGP 53. In the direct-type BLU, a plurality of light sources may be provided at a front surface of the reflective sheet 55, and a diffusion plate may be used in place of the LGP 53.

As can be seen from FIG. 3, the light source 51 may be provided at a side surface of the LGP 53, and may thus output light to the LGP 53.

In this case, the light source 51 may output light (monochromatic light) having a single wavelength (single color), or may output light (white light) in which light signals having different wavelengths are mixed. The BLU 50 according to an exemplary embodiment may include the quantum dot sheet 57, such that the light source 51 may be implemented as a specific light source 51 configured to output monochromatic light (specifically, blue light having a short wavelength).

The above-mentioned light source 51 may be implemented as one of a Light Emitting Diode (LED) and a Cold Cathode Fluorescent Lamp (CCFL), each having low heating power.

The light guide plate (LGP) for use in the edge-type BLU 50 may change the progressing direction of light incident from the side surface, and may emit the resultant light in a forward direction. In order to change the progressing direction of the light, a plurality of convex stripes may be formed on the front surface 53a of the LGP 53, and a plurality of dots may be formed at a back surface 53b of the LGP 53. In addition, the size of the convex stripes and the spacing between the convex stripes may be adjusted in a manner that uniform light may be emitted to the front surface 53a of the LGP 53, and the size of the dots and the spacing between the dots may be adjusted.

In addition, the convex stripes of the front surface 53a of the LGP 53 may be embossed by a printing method, and the dots of the back surface 53b of the LGP 53 may be laser-engraved.

Referring to FIG. 3, some parts L1 of the light incident into the LGP 53 may be scattered by the dots formed at the back surface 53b of the LGP 53, and may be emitted to the front surface 53a of the LGP 53. Other parts L2 of the light incident into the LGP 53 may be reflected into the LGP 53 through the reflective sheet 55 provided to the back surface 53b of the LGP 53. In addition, some of the reflected light L2 may be transferred to the center part of the LGP 53, may be scattered at the center part of the LGP 53, and may be emitted to the front surface 53a of the LGP 53.

As described above, the LGP 53 may emit uniform light to the front surface by refraction, reflection and scattering of light generated from the LGP 53.

The LGP 53 may be formed of transparent polymethylmethacrylate (PMMA) having high stiffness or rigidity, or may be formed of transparent polycarbonate (PC).

The reflective sheet 55 may be provided at the back surface 53b of the LGP 53 as described above, and may reflect some parts of light emitted to the back surface of the LGP 53 in the inside of the LGP 53.

The reflective sheet 55 may be formed by coating base materials with a high-reflectivity material. For example, the reflective sheet 55 may be formed by coating base materials (e.g., polyethylene terephthalate, PET) with high-reflectivity polymer. The quantum dot sheet 57 may convert light emitted to the front surface 53b of the LGP 53 into white light.

In addition, the display apparatus 1 may include an input device 130 to receive an operation command from the user, and the input device 130 may include a plurality of buttons. The display apparatus 1 may include a sound output module configured to output sound related to images. The display apparatus 1 may communicate with a remote controller 150, and may perform an operation on the basis of a manipulation signal received from the remote controller 150.

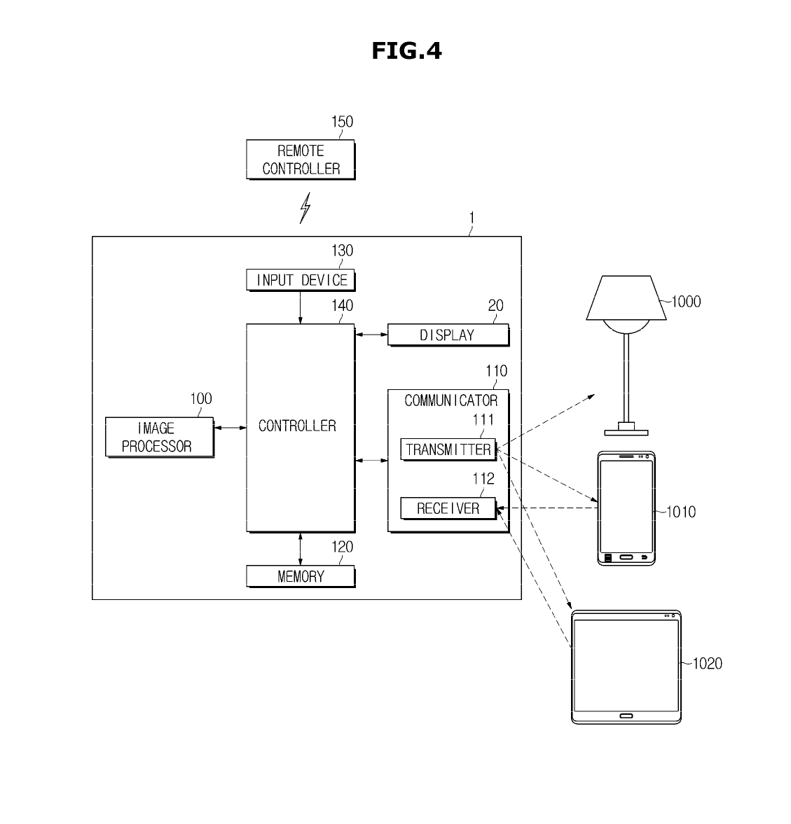

FIG. 4 is a control block diagram illustrating control flow of the display apparatus according to an exemplary embodiment.

Referring to FIG. 4, the display apparatus 1 may include a display 20 configured to display images upon receiving an image signal from the display apparatus 1, an image processor 100 configured to process the image signal and to generate image data capable of being displayed on the display 20, a communicator 110 configured to transmit and receive data to and from external devices 1010 and 1020 or an external lighting device 1000, a memory 120 configured to store various kinds of data related to the operation and control of the display apparatus 1, an input device 130 configured to receive a control command related to the operation of the display apparatus 1, and a controller 140 configured to control the display apparatus 1 and to generate various control signals related to the operation of the display apparatus 1.

In this case, the external device may include a mobile terminal (e.g., a smartphone) 1010, a tablet 1020, etc. The external device may communicate with the display apparatus 1 by wire or wirelessly, and may also be applied to all kinds of devices, each having a display, configured to display images capable of being viewed or listened to by the user without departing from the scope or spirit of the present disclosure.

Referring to FIG. 4, the display 20 may display various images according to external input image signals. The display panel 21 contained in the display 20 may be a light emitting display panel in which a plurality of pixels constructing the display panel 21 may emit light to form images, or may be a non-light-emitting display panel in which a plurality of pixels reflects, transmits, and blocks light to form images. Light emitted by the BLU 50 may be reflected, transmitted, and blocked so that images may be formed and displayed on the display panel 21, and image brightness values may be different from one another according to image type.

The display 20 may be implemented by a cathode ray tube (CRT), a light emitting diode (LED) display, an organic light emitting diode (OLED) display, an active-matrix organic light emitting diode (AMOLED) display, a flexible display, a three-dimensional (3D) display, or the like. In addition, the display 20 may include a touchscreen configured to receive a user's touch command.

The image processor 100 may process an external image signal applied to the display apparatus 1, and may generate (or form) images to be displayed on the display apparatus 1. In this case, the image processor 100 may process the received image signal on a frame basis, and the processed frame-based images may be displayed on the display 20 for user recognition.

The input device 130 may receive an operation command of the display apparatus 1 from the user, and may include a plurality of buttons. In this case, the plurality of buttons may include a power-supply button, channel/volume buttons, a screen control button, a brightness control button, etc.

The user may perform channel switching of the images displayed on the display apparatus 1, may adjust a volume, and may adjust brightness of the screen, through the buttons contained in the input device 130. In addition, if unexpected errors occur in the displayed image or if a screen image is abnormally displayed, the user may also input a screen control command.

The controller 140 may control each of the constituent elements contained in the display apparatus 1 according to an embodiment. In other words, the controller 140 may control the display 20, the image processor 100, the communicator 110, and the memory 120.

A dimming control scheme for use in the controller 140 of the display apparatus 1 may be classified into an LED BLU dimming method and a local dimming method. In accordance with the LED BLU dimming method, LEDs used as a light source of the backlight unit (BLU) may not simultaneously operate, and may be sequentially or selectively blinked according to image characteristics. In accordance with the local dimming method, the image screen is divided into a plurality of sections such that the sections are dimmed.

LED dimming for adjusting brightness of LEDs according to brightness of images may be classified into an analog dimming scheme and a Pulse Width Modulation (PWM) dimming scheme.

The analog dimming scheme may adjust brightness of LED BLU by adjusting the amount of current supplied to the LED BLU. That is, assuming that the amount of current supplied to each LED contained in the LED BLU is reduced by half according to the analog dimming scheme, LED BLU brightness may be reduced by half.

The pulse width modulation (PWM) dimming scheme may adjust LED BLU brightness by adjusting the on-off time ratio of each LED contained in the LED BLU according to a PWM signal. For example, assuming that a PWM signal having the on-off time ratio of 4:1 is supplied to each LED contained in the LED BLU, LED BLU brightness may be 80% of maximum brightness.

The local dimming scheme may divide the backlight unit (BLU) into a plurality of regions, and may allow brightness of an image to be associated with an image signal supplied to the display apparatus 1 such that the BLU is turned off or light intensity is reduced in a region corresponding to a dark part of the image and image brightness is increased in the other region corresponding to a bright part of the image, resulting in improvement of a contrast ratio and implementation of high-definition images.

In other words, the controller 140 may control the image processor 100 so as to analyze image information on the basis of the image signal applied to the display apparatus 1, and may generate a dimming signal for adjusting brightness of images displayed on the display 20 on the basis of the analyzed image signal.

The controller 140 may generate the dimming signal for adjusting brightness of images displayed on the display apparatus 20, and may generate the dimming signal for adjusting brightness of the external lighting device 1000. In this case, the controller 140 may generate the dimming signal for adjusting brightness of the external lighting device 1000, independently of the dimming signal adjusting brightness of images displayed on the display apparatus 20. The controller 140 may also adjust brightness of the external lighting device 1000 using the dimming signal adjusting brightness of images displayed on the display 20.

In more detail, the controller 140 may generate the dimming signal for adjusting brightness of the external lighting device 1000 in proportion to brightness of the image signal generated by the display apparatus 1, and may store data related to the generated dimming signal in the memory 120.

In addition, the controller 140 may control the communicator 110, and may transmit the generated dimming signal to the external lighting device 1000. By the dimming signal applied to the external lighting device 1000, brightness of the external lighting device 1000 may be adjusted, and the user may view optimum-brightness images displayed on the display apparatus 1.

The controller 140 may receive the image signal having brightness information of images generated by the external devices 1010 and 1020 through the communicator 110, and may generate the dimming signal for adjusting brightness of images generated by the external devices 1010 and 1020 on the basis of brightness of the received image signal.

In addition, the controller 140 may generate the dimming signal for adjusting brightness of the external lighting device 1000 on the basis of brightness of the image signals generated by the external devices 1010 and 1020.

The controller 140 may store data related to the dimming signal for adjusting not only brightness of images generated by the external devices 1010 and 1020 but also brightness of the external lighting device 1000 in the memory 120. The controller 140 may control the communicator 110, and may transmit the generated dimming signal to the external devices 1010 and 1020 and the external lighting device 1000. The controller 140 may adjust brightness of the images generated by the external devices 1010 and 1020 upon receiving the dimming signal applied to the external devices 1010 and 1020, and may adjust brightness of the external lighting device 1000 upon receiving the dimming signal applied to the external lighting device 1000.

The controller 140 may control the BLU 50 on the basis of the dimming signal for adjusting brightness of the images displayed on the display 20, and may thus adjust brightness of the images displayed on the display apparatus 1.

The communicator 110 may receive the image signal including brightness information of the images generated by the external devices 1010 and 1020 through a receiver 112, may transmit the received image signal to the controller 140, and may transmit the dimming signal generated by the controller 140 to the external lighting device 1000 or the external devices 1010 and 1020 through a transmitter 111.

The communicator 110 may be coupled to the external devices 1010 and 1020 and the external lighting device 1000 by wire or wirelessly. The communicator 110 may include at least one of a Bluetooth communication module for communicating with a single external device 1010 or 1020 on a one-to-one basis or for communicating with a small number of external devices 1010 and 1020 on a one-to-multiple basis; a Wireless Fidelity (Wi-Fi) communication module for connecting to a local area network (LAN) through an access point (AP) or the like; and a near field communication (NFC) module, such as a ZigBee communication module, for forming a local area network (LAN) between the image processor 100 and the external device 1010 or 1020.

The communicator 110 may implement a wireless communication scheme. The wireless communication scheme may include radio frequency (RF) communication, Wireless Fidelity (Wi-Fi) communication, Bluetooth communication, Zigbee communication, Near Field Communication (NFC), and Ultra Wide Band (UWB) communication. However, although the communication module contained in the communicator 160 may be any one of a Bluetooth communication module, a Wi-Fi communication module, and a near field communication (NFC) module for convenience of description, the scope or spirit of the present disclosure is not limited thereto, and the communication module may also include other communication modules for performing communication according to various communication protocols.

The memory 120 may store data related to operation and control of the display apparatus 1. In more detail, the memory 120 may store data related to the dimming signal for allowing the display apparatus 1 to adjust brightness of the external lighting device 1000, and may store data related to the dimming signal for adjusting not only brightness of the images generated by the external devices 1010 and 1020 but also brightness of the external lighting device 1000.

For example, although the memory 120 may include a high-speed random access memory (RAM), a magnetic disk, an SRAM, a DRAM, a ROM, etc., the scope or spirit of the present disclosure is not limited thereto. In addition, the memory 120 may be detachably coupled to the display apparatus 1. For example, although the memory 120 may include a Compact Flash (CF) card, a Secure Digital (SD) card, a Smart Media (SM) card, a Multimedia Card (MMC), or a memory stick, the scope or spirit of the present disclosure is not limited thereto.

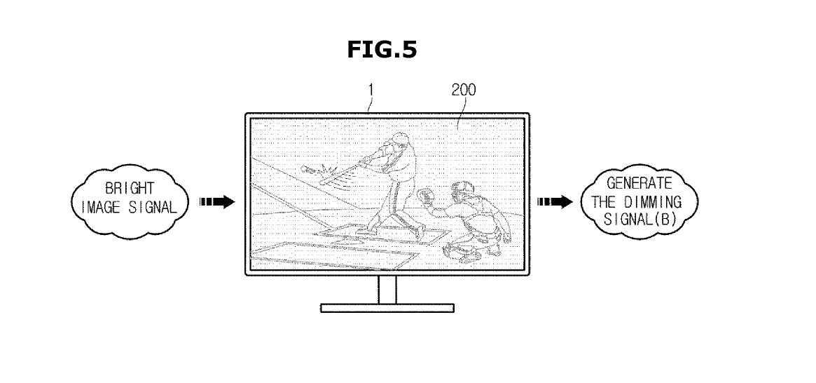

FIGS. 5 to 7 are conceptual diagrams illustrating a method for allowing the display apparatus to generate a dimming signal according to an exemplary embodiment.

Referring to FIG. 5, the display apparatus 1 may receive the image signal needed for image output from the external part. The image signal may include brightness information of images displayed on the display apparatus 1, and may further include an image signal needed for display of a bright image and an image signal needed for display of a dark image. In addition, the bright image and the dark image may correspond to relative concepts, and may not be limited to specific values.

In FIG. 5, if the image signal needed for display of the bright image is input to the display apparatus 1, the display apparatus 1 may generate the dimming signal. As can be seen from FIG. 5, if the display apparatus 1 receives the image signal needed for display of the bright image, the controller 140 may generate a dimming signal B corresponding to data needed for display of the bright image.

The controller 140 may increase intensity of current flowing in the BLU 50 on the basis of the generated dimming signal B, such that the controller 140 may control images displayed on the display 20 to be bright images. In other words, as can be seen from FIG. 5, the bright image 200 may be displayed on the display 20 according to the dimming signal B generated by the bright image signal applied to the display apparatus 1.

The controller 140 may store the dimming signal B generated in response to the data needed for display of the bright image in the memory 120. The stored dimming signal B may control the images displayed on the display apparatus 1 to be bright images, or may be used to adjust brightness of the external lighting device 1000 as will be described later.

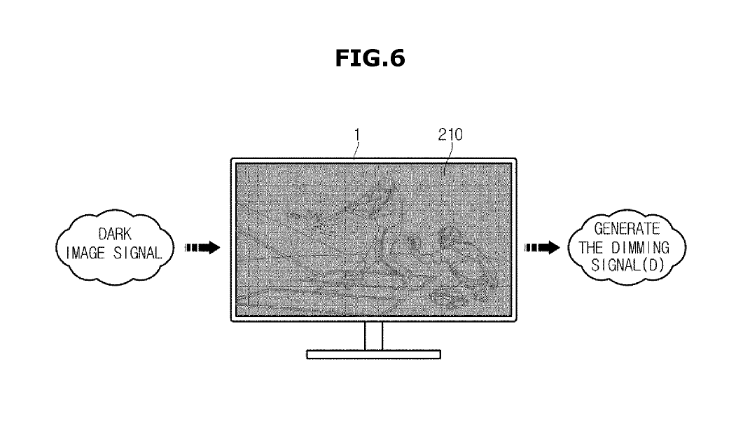

In FIG. 6, when the image signal needed for display of a dark image is input to the display apparatus 1, the display apparatus 1 may generate a dimming signal. As can be seen from FIG. 6, if the display apparatus 1 receives the image signal needed for display of the dark image, the controller 140 may generate a dimming signal D corresponding to data needed for display of the dark image.

The controller 140 may increase intensity of current flowing in the BLU 50 on the basis of the generated dimming signal D, such that the controller 140 may control images displayed on the display 20 of the display apparatus 1 to be dark images. In other words, as can be seen from FIG. 5, the bright image 200 may be displayed on the display 20 according to the dimming signal B generated by the bright image signal applied to the display apparatus 1. In other words, as can be seen from FIG. 6, the dark image 210 may be displayed on the display 20 according to the dimming signal D generated by the dark image signal applied to the display apparatus 1.

The controller 140 may store the dimming signal D generated in response to data needed for display of the dark image in the memory 120. The stored dimming signal D may control the images displayed on the display apparatus 1 to be dark images, or may be used to adjust brightness of the external lighting device 1000 as will be described later.

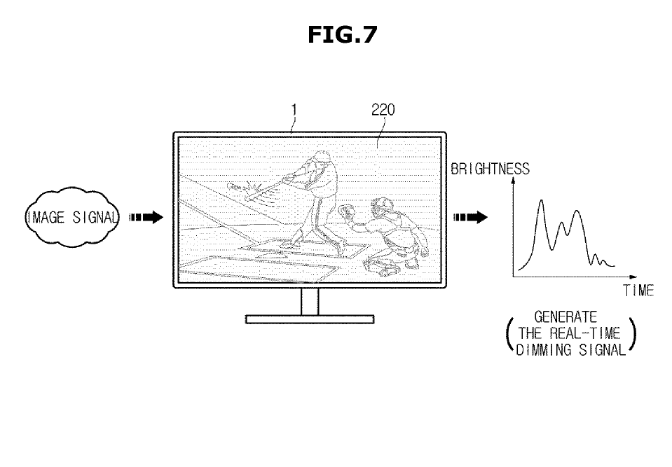

As can be seen from FIG. 7, the dimming signals shown in FIGS. 5 and 6 may be successively displayed in the form of a graph. In other words, if the display apparatus 1 receives the image signal needed for display of the bright image or the dark image, the controller 140 may generate a dimming signal corresponding to data needed for display of the bright image or the dark image.

The image signal received by the display apparatus 1 may include a bright image signal and a dark image signal, and images displayed on the display 20 by the image signal may be displayed as bright images or dark images in real time.

Referring to the graph of FIG. 7, an X-axis may denote a time axis, and a Y-axis may denote brightness of each image. Dots constructing the graph according to lapse of time may denote brightness of the image signal at the corresponding moment, and dots may denote relative brightness of the images displayed on the display 20.

As can be seen from the graph of FIG. 7, the dimming signal may allow image brightness to be changed in real time according to lapse of time, and brightness of the images displayed on the display 20 may also be changed in real time according to the changed dimming signal. If the bright image is displayed on the display 20 and a peripheral region of the display apparatus 1 is dark, the user's eyes are easily fatigued. In contrast, if the dark image is displayed on the display 20 and the peripheral region of the display apparatus 1 is bright, it is difficult to distinguish between light and dark of the displayed images, such that the user may have difficulty in normally and visually recognizing the displayed images. Therefore, there is a need to adjust brightness of the lighting device located in the peripheral region according to brightness of the images displayed on the display 20.

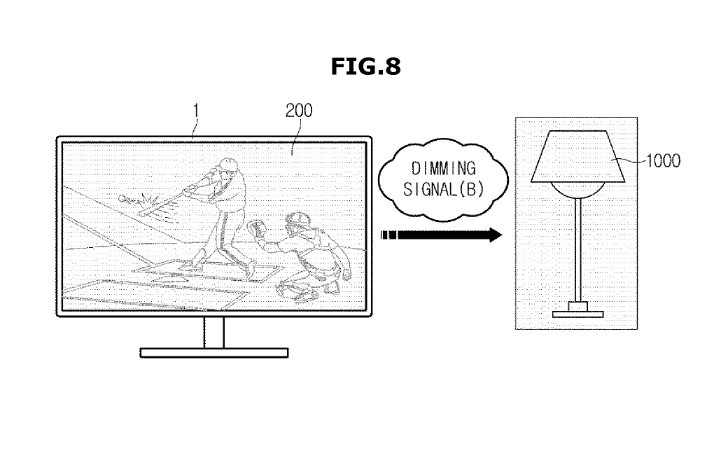

FIGS. 8 to 10 are conceptual diagrams illustrating a method for allowing the display apparatus to transmit a generated dimming signal to the external lighting device according to an exemplary embodiment.

In FIGS. 8 to 10, the scope or spirit of the external lighting device 1000 to be described is not limited to the disclosed shapes, and the external lighting device 1000 may also be applied to all kinds of devices which are located in the peripheral region of the display apparatus 1 and affect brightness and definition (or clarity) of the images displayed on the display apparatus 1. That is, the external lighting device 1000 may include a standing-type lighting device, a stationary lighting device, and a ceiling-mounted-type lighting device, etc.

Referring to FIG. 8, the controller 140 may generate the dimming signal B corresponding to data for allowing the display apparatus 1 to output the bright image 200 as shown in FIG. 5, and may transmit the dimming signal B to the external lighting device 1000 through the transmitter 111 of the communicator 110. The communicator 110 may be coupled to the external lighting device 1000 by wire or wirelessly, and may transmit the dimming signal B according to the wired or wireless communication scheme.

In addition, the dimming signal B may not be directly transmitted from the display apparatus 1 to the external lighting device 1000, and may be transmitted to an external server through the network such that the dimming signal B may be transmitted from the external server to the external lighting device 1000. The wired or wireless communication scheme for transmitting the dimming signal B has already been disclosed in FIG. 4, and as such a detailed description thereof will herein be omitted for convenience of description.

Brightness of the external lighting device 1000 may be adjusted by the dimming signal B received from the display apparatus 1. That is, if the bright image 200 is displayed on the display 20 of the display apparatus 1, brightness of the external lighting device 1000 may also be increased in response to the displayed bright image. In more detail, if the received dimming signal B relates to the bright image 200, the amount of current needed to adjust brightness of the external lighting device 1000 may increase, resulting in increased brightness of the external lighting device 1000.

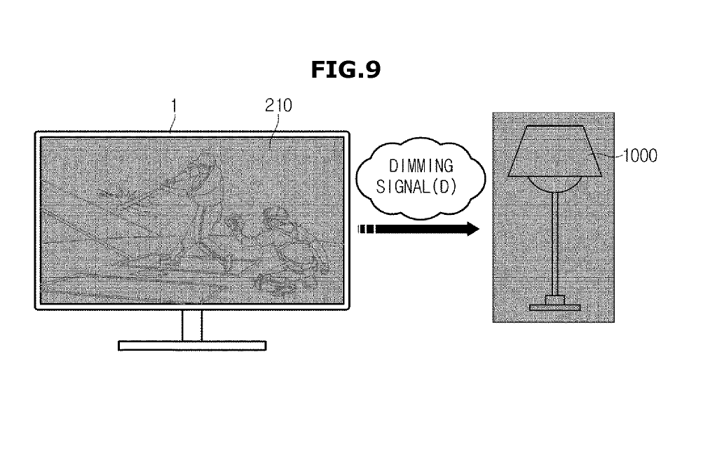

Referring to FIG. 9, the controller 140 may generate the dimming signal D corresponding to data for allowing the display apparatus 1 to output the dark image 210 as shown in FIG. 6, and may transmit the dimming signal D to the external lighting device 1000 through the transmitter 111 of the communicator 110. The communicator 110 may be coupled to the external lighting device 1000 by wire or wirelessly, and may transmit the dimming signal D according to the wired or wireless communication scheme.

In addition, the dimming signal D may not be directly transmitted from the display apparatus 1 to the external lighting device 1000, and may be transmitted to an external server through the network such that the dimming signal D may be transmitted from the external server to the external lighting device 1000.

Darkness of the external lighting device 1000 may be adjusted by the dimming signal D received from the display apparatus 1. That is, if the dark image 210 is displayed on the display 20 of the display apparatus 1, the external lighting device 1000 may enter a relatively dark state in response to the displayed dark image. In more detail, if the received dimming signal D relates to the dark image, the amount of current needed to adjust brightness of the external lighting device 1000 may be reduced such that brightness of the external lighting device 1000 is reduced and the external lighting device 1000 may thus enter a relatively dark state.

Brightness of the image displayed on the display 20 and brightness of the external lighting device 1000 may be generally established to be proportional to each other, such that the brightness of the image displayed on the display 20 and the brightness of the external lighting device 1000 may be changed according to the proportional relationship therebetween. However, the relationship between brightness of the image displayed on the display 20 and brightness of the external lighting device 1000 may be implemented in various ways according to various embodiments of the present disclosure.

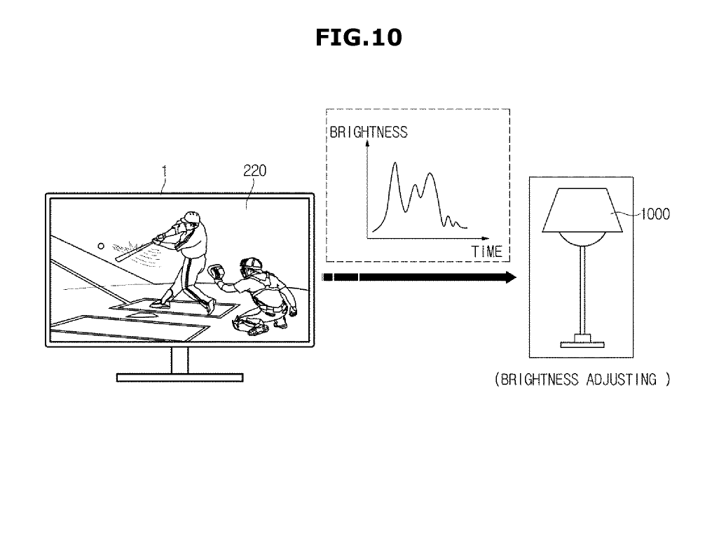

Referring to FIG. 10, the dimming signals formed in a successive graph shape may be transferred from the display apparatus 1 to the external lighting device 1000 as shown in FIGS. 5 and 6.

In other words, if the display apparatus 1 displays the bright image, brightness of the external lighting device 100 may increase. If the display apparatus 1 displays the dark image, brightness of the external lighting device 100 may decrease. The dimming signal generated by the display apparatus 1 may include the bright image signal and the dark image signal. By the above-mentioned dimming signal, brightness of the external lighting device 100 may be changed in real time in response to the image displayed on the display apparatus 1.

Therefore, if the bright image is displayed on the display apparatus 1, brightness of the external lighting device 1000 may be increased in response to the displayed bright image, such that the user may view the displayed bright image without feeling eye fatigue. If the dark image is displayed on the display apparatus 1, brightness of the external lighting device 1000 may be reduced in response to the displayed dark image, such that the user may view high-definition images.

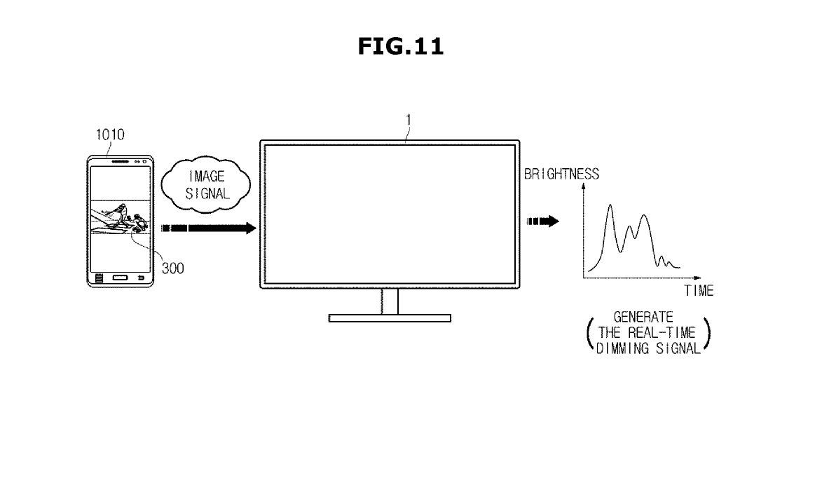

FIG. 11 is a conceptual diagram illustrating a method for allowing the display apparatus to receive an image signal from the external device as well as to adjust image brightness according to an exemplary embodiment.

Referring to FIG. 11, the display apparatus 1 may receive an image signal from an external device 1010. Although an exemplary embodiment of FIG. 11 describes that the external device 1010 is used as a mobile terminal (e.g., a smartphone), exemplary embodiments are not limited thereto, and all kinds of external devices may be applied to an exemplary embodiment of FIG. 11. The user may view images through the external device 1010. Brightness of the image 300 displayed through the external device 1010 may also be changed in real time in the same manner as in the images displayed on the display apparatus 1. As described above, the display apparatus 1 may generate the dimming signal for adjusting image brightness on the basis of the image signal needed for image display, such that the display apparatus 1 may generate the dimming signal upon receiving the image signal.

The image signal transferred from the external device 1010 to the display apparatus 1 may include brightness information of the image. The controller 140 may generate the dimming signal corresponding to brightness in a manner that the external device 1010 outputs the bright image or the dark image.

Referring to the dimming signal graph of FIG. 11, brightness signals of images displayed on the external device 1010 may be successively displayed as shown in FIG. 7. Referring to the graph of FIG. 11, an X-axis may denote a time axis, and a Y-axis may denote brightness of each image. Dots constructing the graph according to lapse of time may denote brightness information of the image signal at the corresponding moment, and dots may denote relative brightness of the images displayed on the external device 1010.

Brightness of the image 300 displayed on the external device 1010 is changed in real time. Thus, assuming that the image 300 displayed on the external device 1010 is bright and the peripheral part is dark, the user's eyes are easily fatigued. In contrast, assuming that the image 300 displayed on the external device 1010 is dark and the peripheral region is bright, it is difficult to distinguish between light and dark of the image 300, such that the user may have difficulty in normally and visually recognizing the image. Therefore, there is a need to adjust brightness of the lighting device located in the peripheral region according to brightness of the image 300 displayed on the external device 1010.

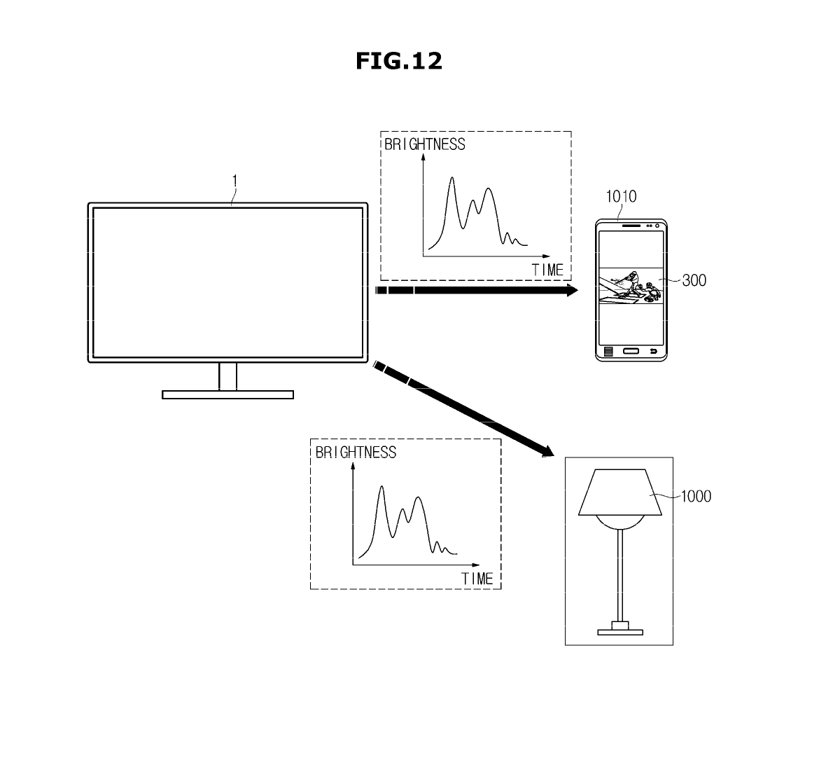

FIG. 12 is a conceptual diagram illustrating a method for transmitting the dimming signal generated by the display apparatus to the external device and the external lighting device.

Referring to FIG. 12, the transmitter 111 contained in the communicator 110 may transmit the dimming signal generated by the controller 140 to the external device 1010 and the external lighting device 1000 on the basis of the image signal of the external device 1010.

Although the dimming signal generated to adjust image brightness may be different from the signal for adjusting brightness of the external device 1010 and the signal for adjusting brightness of the external lighting device 1000 as described in FIG. 11, exemplary embodiments are not limited thereto. A brightness of the external device 1010 and a brightness of the external lighting device 1000 may be adjusted using the same dimming signal.

The dimming signal generated by the controller 140 of the display apparatus 1 may be transmitted to the external device 1010 through the communicator 110, such that brightness of the image displayed on the external device 1010 may be adjusted. Simultaneously with the above-mentioned situation, the dimming signal may also be transmitted to the external lighting device 1000 and brightness of the image displayed on the external device 1010 is changed in real time, brightness of the external lighting device 1000 may also be changed in real time. As a result, if the bright image is displayed on the external device 1010, brightness of the external lighting device 1000 may be increased in response to the displayed bright image, such that the user may view the displayed bright image without experiencing eye fatigue. If the dark image is displayed on the external device 1010, brightness of the external lighting device 1000 may be reduced in response to the displayed dark image, such that the user may view a high-definition image.

The communicator 110 may be coupled to the external device 1010 or the external lighting device 1000 by wire or wirelessly, and may transmit the dimming signal according to the wired or wireless communication scheme.

In addition, the dimming signal may not be directly transmitted from the display apparatus 1 to the external device 1010 and the external lighting device 1000, and may be transmitted to an external server through the network such that the dimming signal may also be transmitted from the external server to the external device 1010 and the external lighting device 1000.

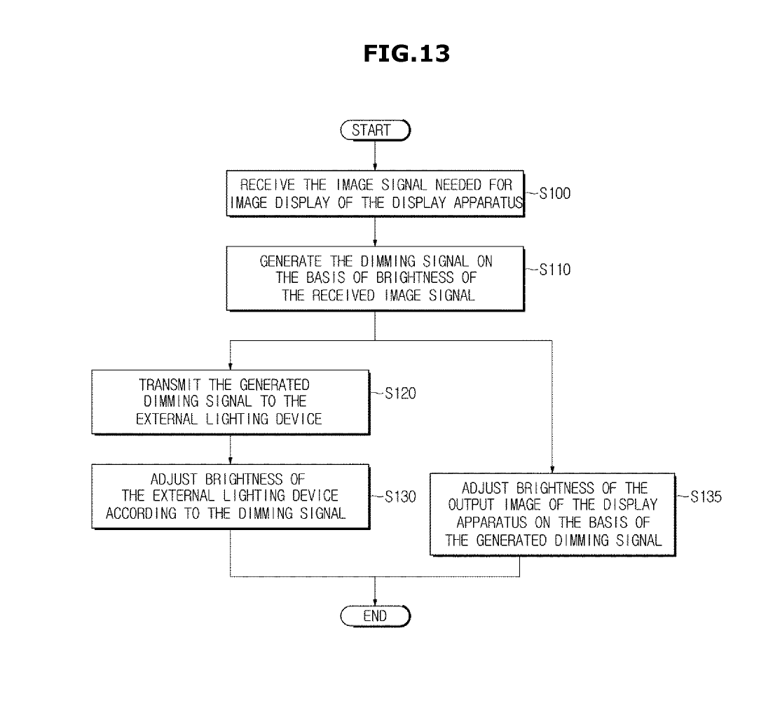

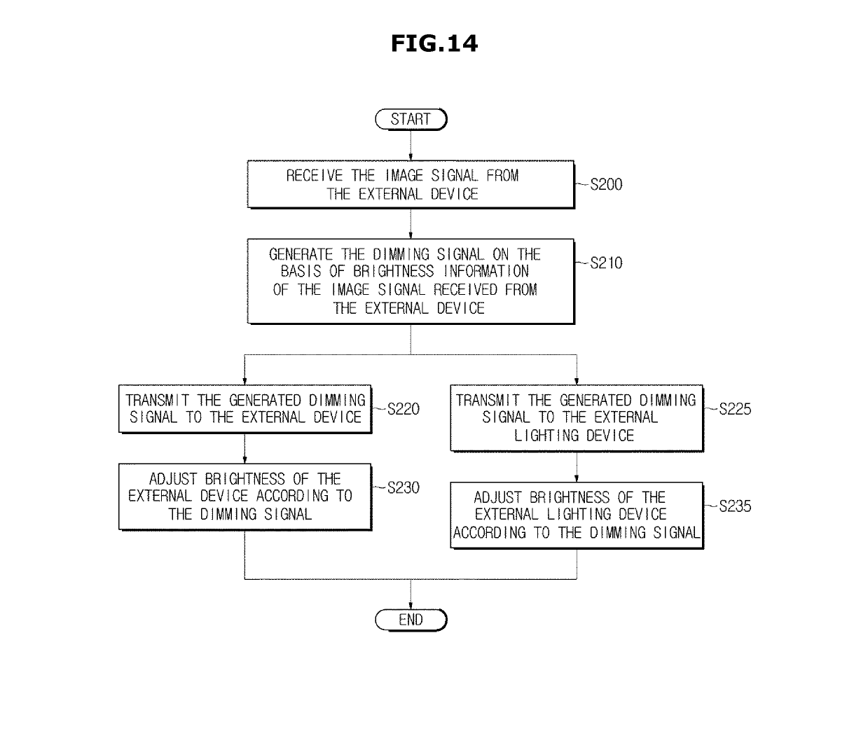

FIGS. 13 and 14 are flowcharts illustrating a method for controlling the display apparatus according to an exemplary embodiment.

Referring to FIG. 13, the communicator 110 of the display apparatus 1 may receive an image signal needed for image display from the external part of the display apparatus 1 (S100), and the received image signal may be transferred to the controller 140. In this case, the image signal received from the external part may include image brightness information.

The controller 140 may generate the dimming signal on the basis of brightness information of the external image signal received by the display apparatus 1 (S110). The dimming signal generated by the controller 140 may denote an electrical signal capable of controlling the BLU 50 of the display apparatus 1 according to the degree of brightness and darkness (i.e., a contrast ratio) of the image.

In addition, the dimming signal generated by the controller 140 may denote an electrical signal capable of adjusting brightness of the external lighting device 1000 in proportion to brightness of the image signal generated by the display apparatus 1.

The transmitter 111 contained in the communicator 110 may transmit the dimming signal generated by the controller 140 to the external lighting device 1000 (S120). In this case, the dimming signal may be transmitted to the external lighting device 1000 according to the wired or wireless communication scheme.

The intensity of current flowing in the BLU 50 may be adjusted according to the dimming signal generated by the controller 140, such that brightness of the image displayed on the display apparatus 1 may be adjusted (S135).

Brightness of the external lighting device 1000 may be adjusted on the basis of the dimming signal transferred from the display apparatus 1 to the external lighting device 1000 (S130), and brightness of the external lighting device 1000 may be changed in proportion to brightness of the image displayed on the display apparatus 1, such that the user who views the image displayed on the display apparatus 1 may view a high-definition image without experiencing eye fatigue caused by influence of the external lighting device 1000.

Referring to FIG. 14, the communicator 110 of the display apparatus 1 may receive the image signal needed for image display from the external device 1010 or 1020 (S200). The received image signal may be transmitted to the controller 140. In this case, the image signal received from the external device 1010 or 1020 may include brightness information of the image.

The controller 140 may generate the dimming signal on the basis of brightness information of the image signal transferred from the external devices 1010 and 1020 to the display apparatus 1 (S210). The dimming signal generated by the controller 140 may denote an electrical signal capable of adjusting brightness of the output images of the external devices 1010 and 1020 according to brightness information of the image signals received from the external devices 1010 and 1020.

The transmitter 111 contained in the communicator 110 may transmit the dimming signal generated by the controller 140 to the external devices 1010 and 1020 (S220). Simultaneously with the above-mentioned situation, the transmitter 111 may also transmit the dimming signal to the external lighting device 1000 (S225). In this case, the dimming signal may be transmitted to the external lighting device 1000 according to the wired or wireless communication scheme.

Brightness of the images displayed on the external devices 1010 and 1020 may be adjusted on the basis of the dimming signal generated by the controller 140 (S230), and at the same time brightness of the external lighting device 1000 may be adjusted (S235). That is, the controller 140 of the display apparatus 1 may generate the dimming signal for adjusting brightness of the output images of the external devices 1010 and 1020 on the basis of the image signals of the external devices 1010 and 1020, such that the controller 140 may control brightness of the external lighting device 1000 using the generated dimming signal.

Therefore, since brightness of the external lighting device 100 may be changed according to brightness of the images displayed on the external devices 1010 and 1020, the user who views the images displayed on the external devices 1010 and 1020 may view high-definition images without experiencing eye fatigue caused by influence of the external lighting device 1000.

The above-described exemplary embodiments are merely exemplary.

As is apparent from the above description, the display apparatus and the method for controlling the same according to exemplary embodiments can be interoperable with illumination control of an external lighting device using the dimming control technology of the display apparatus, such that images displayed on the display apparatus are not dependent upon illumination of the external lighting device, resulting in implementation of an optimum image display environment.

The display apparatus may perform dimming control of brightness of images displayed on the external device, such that an optimum image display environment can be implemented in all the external devices contained in the environment including the display apparatus.

Although one or more exemplary embodiments have been shown and described, it should be appreciated by those skilled in the art that changes may be made in the exemplary embodiments without departing from the principles and spirit of the disclosure, the scope of which is defined in the claims and their equivalents.

What is claimed is:

1. A display apparatus comprising:
a display configured to display an image;
a controller configured to generate a dimming signal for adjusting a brightness of an external lighting device based on a brightness of an image signal outputted from the display apparatus; and
a communicator configured to transmit the dimming signal to the external lighting device to adjust the brightness of the external lighting device based on the generated dimming signal.

2. The display apparatus according to claim 1, wherein the controller is configured to generate a dimming signal for adjusting the brightness of the external lighting device in proportion to the brightness of the image signal outputted from the display apparatus.

3. The display apparatus according to claim 1, wherein the controller is configured to generate a dimming signal for adjusting a brightness of an image outputted from an external device based on a brightness of the image signal outputted from the external device.

4. The display apparatus according to claim 1, wherein the controller is configured to generate a dimming signal for adjusting the brightness of the external lighting device based on a brightness of an image signal outputted from an external device.

5. The display apparatus according to claim 3, wherein the controller is configured to generate a dimming signal for adjusting the brightness of the image outputted from the external device in proportion to the brightness of the image signal outputted from the external device.

6. The display apparatus according to claim 4, wherein the controller is configured to generate a dimming signal for adjusting the brightness of the external lighting device in proportion to the brightness of the image signal outputted from the external device.

7. The display apparatus according to claim 1, wherein the controller is configured to control a backlight unit (BLU) of the display apparatus based on the generated dimming signal, thereby adjusting a brightness of an image outputted from the display apparatus.

8. The display apparatus according to claim 3, wherein the communicator is configured to transmit a dimming signal, generated to adjust the brightness of the image outputted from the external device, to the external device.

9. The display apparatus according to claim 4, wherein the communicator is configured to transmit the dimming signal, generated to adjust the brightness of the external lighting device, to the external lighting device.

10. The display apparatus according to claim 1, wherein the communicator is configured to receive an image signal including brightness information of an image outputted from an external device.

11. A method for controlling a display apparatus comprising:
receiving an image signal needed to display an image on the display apparatus;
generating a dimming signal for adjusting brightness of an external lighting device based on a brightness of the received image signal; and
transmitting the dimming signal to the external lighting device to adjust the brightness of the external lighting device based on the generated dimming signal.

12. The method according to claim 11, further comprising:
receiving an image signal including brightness information of an image outputted from an external device.

13. The method according to claim 12, further comprising:
generating a dimming signal for adjusting the brightness of the image outputted from the external device based on the brightness of the image signal outputted from the external device.

14. The method according to claim 12, further comprising:
generating a dimming signal for adjusting the brightness of the external lighting device based on a brightness of an image signal outputted from the external device.

15. The method according to claim 11, wherein the generating the dimming signal comprises:
generating a dimming signal for adjusting the brightness of the external lighting device in proportion to the brightness of the received image signal.

16. The method according to claim 13, wherein the generating the dimming signal comprises:
generating a dimming signal for adjusting the brightness of the image outputted from the external device in proportion to the brightness of the image signal outputted from the external device.

17. The method according to claim 14, wherein the generating the dimming signal comprises:
generating a dimming signal for adjusting the brightness of the external lighting device in proportion to the brightness of the image signal outputted from the external device.

18. The method according to claim 11, further comprising:
controlling a backlight unit (BLU) of the display apparatus based on the generated dimming signal, thereby adjusting a brightness of an image outputted from the display apparatus.

19. The method according to claim 13, further comprising:
transmitting the dimming signal, generated to adjust the brightness of the image outputted from the external device, to the external lighting device.

20. The method according to claim 14, further comprising:
transmitting the dimming signal, generated to adjust brightness of the external lighting device, to the external lighting device.
